(19) United States
(12) Patent Application Publication
(10) Pub. No.: US 2022/0090445 A1
(43) Pub. Date: Mar. 24, 2022

(54) SYSTEM FOR CLOSING AN OPENING

(71) Applicant: JØRN KRAB HOLDING KBH APS, Copenhagen K (DK)

(72) Inventors: Svend Erik Paulsen Dahl, Hedehusene (DK); Jakob Blauenfeldt-Dydensborg, Dragør (DK); Jørn Krab Jensen, Copenhagen K (DK)

(21) Appl. No.: 17/418,317

(22) PCT Filed: Dec. 27, 2019
(86) PCT No.: PCT/EP2019/087120

§ 371 Date: Jun. 25, 2021

(30) Foreign Application Priority Data
Dec. 28, 2018 (DK) PA201870872

(51) Int. Cl. E06B 9/322; E06B 9/302; E06B 9/327

(52) U.S. Cl. CPC E06B 9/322; E06B 2009/3222; E06B 9/327; E06B 9/302

(57) ABSTRACT

The invention relates to a system (1′) for closing an opening (2), the system (1′) comprising
a scissor-type guide (20) comprising a fixed first end (20′) and a free, second end (20″);
a tilt bracket (70) arranged spaced apart from the first end (20′) at a fixed distance in a first direction (D₁)
a plurality of lamellae (30), each lamella (30) having an elongate plate shape extending in a second direction (D₂) the lamellae (30) being guidable between a retracted position, and an extended position;
a conveyor (40)
a tilt rail (60) for tilting said lamella (30) between an open state and a closed state;
a tilt lever (80) connected to said free, second end (20″) of the scissor-type lamella guide (20), to the tilt rail (60) and to the conveyor (40);
   wherein the tilt lever (80) comprises a guide member (85); and
   wherein said system (1′) is configured for bringing the guide member (85) into contact with a curved guide surface (73), whereby the guide member (85) engages the curved guide surface (73) and is translated in a third direction (D₃), such that the tilt lever (80) is rotated and translates the tilt rail (60) to rotate the lamellae (30)

The present invention relates to a system for closing an opening. More particularly, the present invention may in certain aspects relate to a blind for selectively limiting or preventing passage of light, sound and/or air through an opening. The opening may be an opening in a building structure, for example a window or door opening or a façade element. The system according to the invention relates to the type having a scissor-type guide, for guiding tilt-able lamellae between a retracted position, and an extended position, and where the lamellae may be rotated from an open state to a closed or shut state.

### BACKGROUND OF THE INVENTION

Scissor-type guides for guiding lamellae are used e.g. heavier type of blinds, such as for use on the external side of a building structure, e.g. for regulating light, sound and possibly also air into the building structure though openings therein. Such opening may be windows or doors in a wall of the building structure, or overhead lighting openings. They may also be utilized as façade elements, e.g. build into frames on the façade.

Such systems often need one drive mechanism for moving the lamellae between a retracted position, and an extended position (and back), and one for rotating the lamellae between an open stat and a closed (shut) state. As drive mechanisms are complex, expensive and hard to integrate, there is a need for system that may only use a single drive mechanism.

European patent application EP 2 540 951 A1 discloses a “Venetian” blind having a plurality of “slats” or lamellae whose left end portion cooperates with a primary lift mechanism, in the form of a scissor type guide, and a primary tilt mechanism. The right end portion of the lamellae cooperates with a secondary lift mechanism and a secondary tilt mechanism. An electric drive motor synchronously drives the lift mechanisms for lifting and lowering lamellae, and tilt mechanisms for tilting the lamellae. The lamellae are formed by the associated twistable tilting axes. The tilt mechanisms are independently driven to twist the slats.

The device disclosed in EP 2 540 951 is very complex and space consuming. Therefore, there is a need for a system for closing an opening that may be less space consuming. Further, EP 2 540 951 does not provide disclosure of how the lamellae are rotated.

It is therefore an object of the invention to provide a system for closing an opening, such as blind, which has a simple and reliable way of both extending and retraction a scissor-type guide for lamellae and rotating the lamellae between an open state and a closed state by use of only a single drive mechanism.

It is a further object of the invention to provide a stable mechanism of both extending and retraction a scissor-type guide for lamellae and rotating the lamellae between an open state and a closed state.

It is further object of the invention to provide a system for closing an opening, such as blind, which is compact.

### SUMMARY OF THE INVENTION

One or more objects of the invention may be achieved by a system for closing an opening, the system comprising
a scissor-type guide comprising a fixed first end and a free, second end which may be extended away from and retracted towards the first end in a first direction;
a tilt bracket arranged spaced apart from the first end at a fixed distance in the first direction;
a plurality of lamellae, each lamella having an elongate plate shape extending in a second direction perpendicular to said first direction, each lamella being rotatably connected to said scissor-type guide, and the lamellae being guidable by the scissor-type guide in the first direction between
   a retracted position adjacent to said fixed, first end of the scissor-type guide, and
   an extended position, where said lamellae are distributed along the fixed distance between said first end of the scissor-type guide and the tilt bracket;
a conveyor configured to extract and contract the scissor type guide in said first direction;
a tilt rail configured for tilting said lamella between an open state and a closed state;
a curved first guide surface formed in or on said tilt bracket; and
a tilt lever connected to said free, second end of the scissor-type guide, to the tilt rail and to the conveyor;
   where the tilt lever comprises a guide member; and
   wherein said system is configured for bringing the guide member into contact with the curved guide surface, whereby the guide member engages the curved guide surface and is translated in a third direction, which is perpendicular to both said first direction and said second direction, such that the tilt lever is rotated and translates the tilt rail in the third direction to rotate the lamellae.

Hereby is achieved a simple and space saving system.

The opening may be a rectangular opening. The opening, such as a rectangular opening may be an opening in a building, such as an opening in a wall, façade or roof-structure of a building, such as an office building, a residential building or a factory building.

In an embodiment, the tilt bracket comprises a catch formed in a top side—which may be called first edge—of the tilt bracket, where said catch forms a bearing for a lamella shaft arranged through the tilt lever, and connecting to the free, second end of the scissor-type guide.

There by a very simple way of stabilising at least the free, second end of the scissor-type guide during rotation of the lamellae between the open state, and the closed/shut state is obtained.

In any embodiment, the curved, first guide surface may form part of a guide track, formed in said tilt bracket, said guide track also comprising a curved, second guide surface arranged opposite to said curved, first guide surface, and where the guide member is configured, such that it engaged both the curved, first guide surface and the curved, second guide surface. Thereby, an efficient way of securing the reverse movement of the guide member when the lamellae are rotated from the closed state to the open state is obtained.

In a further embodiment, the system may further comprise two or more parallelogram connectors being rotationally connected to the tilt rail, each of said two parallelogram connectors being connected to a point, which is in a fixed position relative to the fixed, first end of the scissor-type guide and the tilt bracket, by a rotational joint. Thereby, a parallelogram type tilt mechanism is obtained which will stabilise the translation in the third direction of the tilt rail, such that it is ensured that the translation of the tilt rail occurs uniformly over the entire length of the tilt rail.

In a further embodiment, the system may comprise a tilt member rotationally connected to each of said parallelogram connectors. Thereby, the parallelogram type tilt mechanism is reinforced, and even more stable.

In a further embodiment each of the lamellae comprises a lamella shaft, which is rotationally connected to the scissor guide and which is non-rotationally connected to a tilt arm, and wherein the tilt arm is slideably and rotationally connected to an elongate guide track formed in the tilt rail.

In a further embodiment the tilt lever comprises
a first end connected to the guide member, and to a follower fixedly connected to the conveyor; and
an opposite second end slideably and rotationally connected to the tilt member;
   and a lamella shaft is arranged through the a central portion of the tilt lever and connecting to the free end of the scissor-type guide.

In a further embodiment, the system may comprise a first arm, which is rotationally connected at one end thereof to the follower, and rotationally connected at an opposite end thereof to the first end of the tilt lever.

In a further embodiment, the system may comprise a first side rail, wherein said first end of said scissor-type guide structure and said tilt bracket are arranged at opposite ends of said side rail.

The system according to any one of the above mentioned embodiment may advantageously be a blind.

The blind may be of the type used for the external side of the building. Thus, it may be located on the external side (outside) of a door, a window, or a panels of a glass façade in a wall opening or in a roof opening. However, the blind may also be located on the inside.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1, in a perspective view, shows a blind according to an embodiment of the invention:

FIG. 2A, in a perspective view, shows a detail at a first end of the blind shown in FIG. 1;

FIG. 2B, in a perspective view, shows a detail at a second end of the blind shown in FIG. 1;

FIG. 3A, shows as section of a blind according to an embodiment of the invention, where a set of lamella of the blind is retracted/retracted to a position adjacent a first end of the blind;

FIG. 3B, shows a section of the blind shown in FIG. 3B, where the set of lamella are extended to a position partially towards the second end of the blind;

FIG. 3C, shows a section of the blind shown in FIGS. 3A and B, where the set of lamella are fully extended to a position, where the lamella are distributed evenly between the partially towards the first and second ends of the blind; and where the lamella are not tilted so that the blind in an open state;

FIG. 3D, shows a section of the blind shown in FIGS. 3A-C, where the set of lamella are fully extended to a position, as in FIG. 3C, and where the lamella are partly tilted towards a closed state of the blind;

FIG. 3E, shows a section of the blind shown in FIGS. 3A-D, where the set of lamella are fully extended to a position, as in FIG. 3C, and where the lamella are fully tilted towards a closed state of the blind;

FIG. 4A, in a perspective view, shows a side rail for a blind according to the invention;

FIG. 4B is a front view of the side rail shown in FIG. 4A;

FIG. 4C is a side view of the side rail shown in FIGS. 4A-B;

FIG. 4D is a back view of the side rail shown in FIGS. 4A-C;

FIG. 5A, in a perspective view, shows details of the side rail of FIGS. 4A-D from a front side, and in an open state of the blind;

FIG. 5B, shows the side rail of FIG. 5A, and in a partly closed state of the blind;

FIG. 5C, shows the side rail of FIGS. 5A-B, and in a closed state of the blind;

FIG. 6A, in a perspective view, shows details of the side rail of FIGS. 4A-D from a back side, and in an open state of the blind;

FIG. 6B, shows the side rail of FIG. 6A, and in a partly closed state of the blind;

FIG. 6C, shows the side rail of FIGS. 6A-B, and in a closed state of the blind;

FIG. 7 is a detailed view of a portion of a scissor-type guide;

FIG. 8A, in a perspective view, shows a section of a blind according to an alternative embodiment of the invention, where a set of lamella of the blind is retracted/retracted to a position adjacent a first end of the blind;

FIG. 8B, shows a section of the blind shown in FIG. 8B, where the set of lamella are extended to a position partially towards the second end of the blind;

FIG. 8C, shows a section of the blind shown in FIGS. 8A and B, where the set of lamella are fully extended to a position, where the lamella are distributed evenly between the partially towards the first and second ends of the blind; and where the lamella are not tilted so that the blind in an open state;

FIG. 8D, shows a section of the blind shown in FIGS. 8A-C, where the set of lamella are fully extended to a position, as in FIG. 8C, and where the lamella are partly tilted towards a closed state of the blind;

FIG. 8E, shows a section of the blind shown in FIGS. 8A-D, where the set of lamella are fully extended to a position, as in FIG. 8C, and where the lamella are fully tilted towards a closed state of the blind;

FIG. 9A shows details (circle C in FIG. 8A) from a first end of the blind shown in FIGS. 8A-E, when the lamellae are in the position shown in FIG. 8A;

FIG. 9B show details (circle D in FIG. 8D) from a second end of the blind shown in FIGS. 8A-E, when the lamellae are in the position shown in FIG. 8D;

FIG. 10A, in a partially see-though side view, shows a blind similar to that of FIGS. 8A-E, with the lamellae 30 in the same position as in FIG. 8A;

FIG. 10B, also in a partially see-though side view, shows the blind of FIG. 10A, with the lamellae 30 in the same position and state as shown in FIG. 8E.

### DETAILED DESCRIPTION OF THE EMBODIMENTS

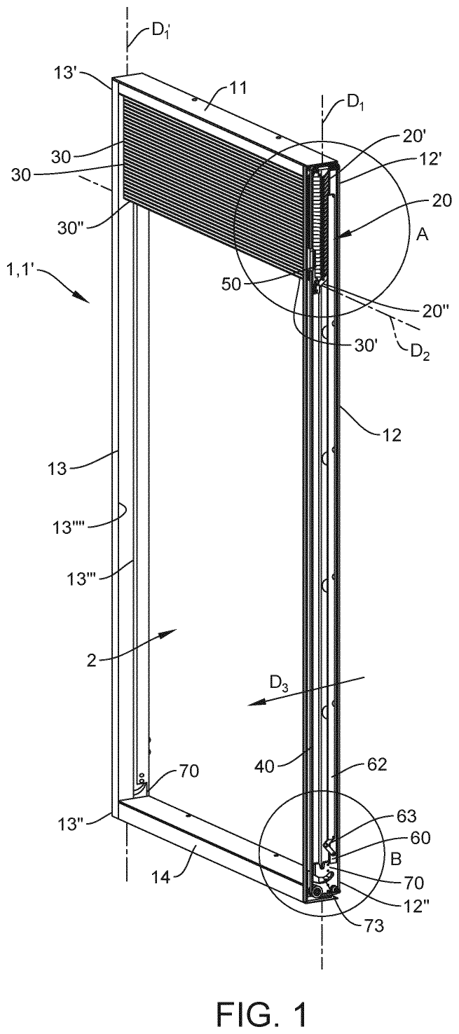

FIG. 1 shows a system 1′ for closing an opening 2, such as a blind, according to an embodiment of the invention. The system 1′ comprises a scissor-type guide 20, a set of lamellae 30, a conveyor 40, and a tilt bracket 70. A scissor type guide may alternatively be called a “guide of the scissor type” or simply a guide. The scissor-type guide 20 is configured for guiding the lamellae 30 along a linear path between a retracted position and an extended or extracted position. The lamellae 30 are connected to the scissor-type guide 20. The conveyor 40 is configured for driving the scissor type guide 20, and thereby the lamellae 30 connected thereto—between the retracted position—as shown in FIG. 1—where all of the lamellae 30 are positioned adjacent to a fixed, first end of 20′ of the scissor-type guide 20—and an extended/extracted position along a first direction D₁, which may be defined as a line between the fixed, first end 20′ of the scissor-type guide 20, and a second end 20″ of the scissor-type guide 20, which second end 20″ is moveable relative to the fixed, first end 20′ of the scissor-type guide 20.

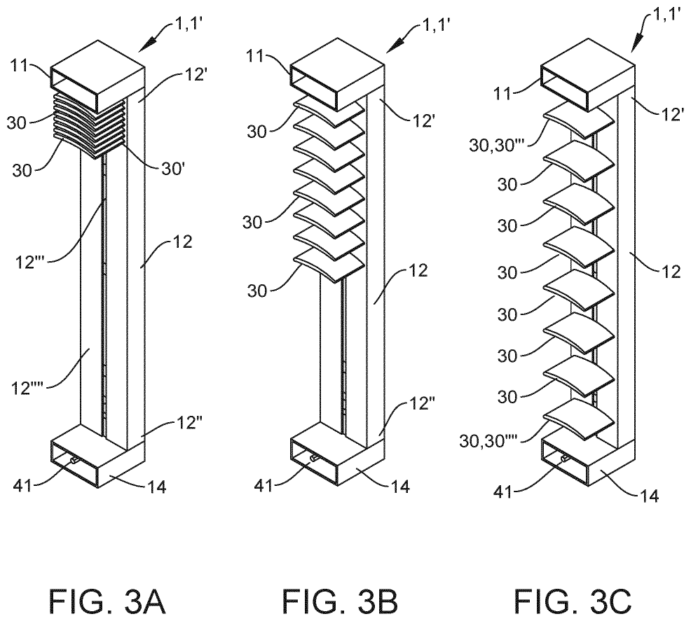

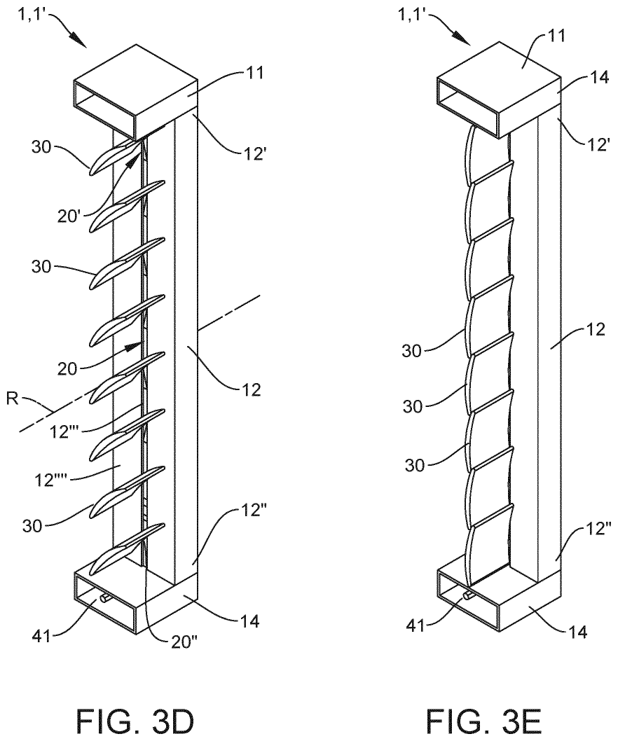

In the extended position, the lamellae 30 are spaced apart from each other and distributed along the first direction, D₁, and the moveable, second end 20″ of the scissor-type guide 20 has been brought to a position adjacent to the tilt bracket 70, which is spaced apart from the fixed, first end 20′ of the scissor-type guide 20 in the first direction, D₁. An example of lamellae 30 being extended to the fully extended position may be seen in FIG. 3C. When the lamellae 30 are in the retracted position, as shown in FIG. 1 or 3A, they are brought close to each other, such as in direct contact with each other.

The tilt bracket 70 is arranged at a suitable distance away from the first end 20′ of the scissor-type guide in the first direction D₁. Thus, the first direction may alternatively be defined by a straight line extending through the fixed, first end 20′ of the scissor-type guide 20 and the tilt bracket. The free, second end 22″ of the scissor-type guide 20 is movable along the first direction D₁.

The tilt bracket 70 serves the purpose of aiding the tilting of the lamellae 30 between an open state and a closed state. This will be described in further detail further below.

The system 1′ may be installed in or on a building structure (not shown), e.g. as a façade element or in an opening in the building structure, such as a window opening in a wall or in a roof. The system 1′ is configured to close an opening to or in which is arranged.

In the following the system 1′ is exemplified by a blind 1 configured for closing an opening 2 such that the lamella 30 can be brought to decrease or prevent light from passing through the opening 2.

In a system 1′/blind 1 according to an embodiment of the invention, the scissor-type guide 20, the set of lamellae 30, the conveyor 40 and the tilt bracket 70, may be connected directly to the building structure, such as to frame parts of a window or door opening, or the blind 1 may further comprise side rails 12, 13, which side rails 12, 13 are then connectable to the building structure. Alternatively, or additionally the blind 1 may comprise first and second end members 11, 14.

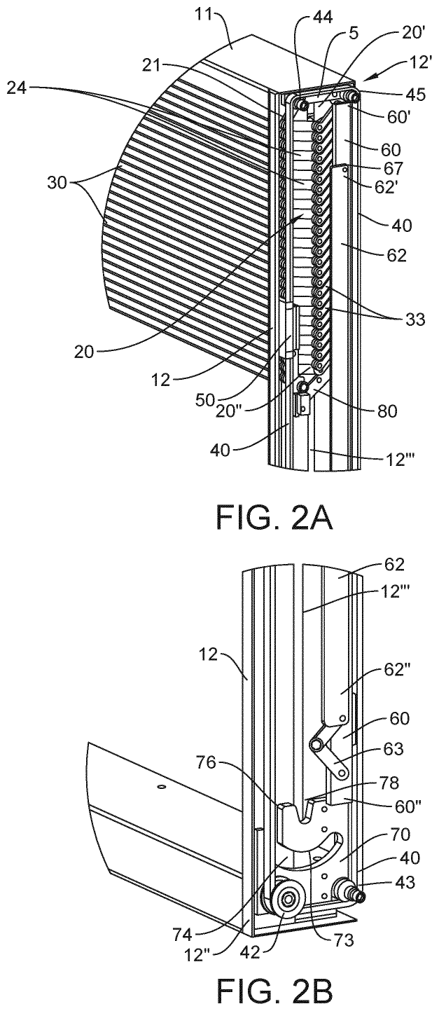

In cases where the blind 1 does not comprise side rails or end members, the first end 20′ of the scissor-type guide 20, the conveyor 40, and the tilt bracket 70 may be fixed directly to the building structure, e.g. via suitable intermediary brackets. In the embodiment shown in FIG. 2A the first end 20′ of the scissor-type guide 20 is connected to a first end bracket 5, which in the figure is connected to the first side rail 12. However, in other (not shown) embodiments a similar first end bracket 5 may be connected directly to the building structure, or to a first end member 11.

In an embodiment, the blind 1 comprises two side rails, a first side rail 12 and a second side rail 13. The first and second side rails 12, 13 are elongate and arranged in parallel with each other. A scissor-type guide 20 may be arranged at least at the first side rail 12. The first end 20′ of the scissor-type guide 20 may in this case be connected to the first side rail 12. Further, the conveyor 40 may be connected to the first side rail 12. Further, tilt bracket 70 may be connected to the first side rail 12.

In another embodiment, the blind 1 alternatively comprises two end members, a first end member 11 and a second end member 14. The first and second end member 11, 14 are elongate and arranged in parallel with each other. The first end 20′ of the scissor-type guide 20 may in this case preferably be connected to the first end member 11. The tilt bracket 70 may be connected to the second end member 14. The conveyer 40 may be connected to the first and/or the second end member 11, 14.

Embodiments (not shown), where the blind 1 or system 1′ comprises a first end member 11 only, and no oppositely arranged second end member, are also conceivable. In this case, at least one scissor-type guide 20 is, at its first end 20′ connected to the first end member 11, and the tilt bracket 70 must be connected to the building structure, in which the system 1′/blind 1 is installed.

In a further embodiment, and as shown in FIG. 1, first and second side rails 12, 13, as discussed above, form part of a closed frame 10, the frame 10 further comprising a first end member 11 and a second end member 14.

The first side rail 12 is elongate and has a first end portion 12′ and a second end portion 12″. Likewise, the second side rail 13 is elongate and has a first end portion 13′ and a second end portion 13″. The above mentioned first longitudinal direction D₁, may alternatively be defined by the longitudinal direction of the elongate first or second side rails 12, 13.

The first end member 11 is connected to and interconnects the first end portions 12′, 13′ of the first and second rails 12, 13. Likewise the second end member 14 is connected to and interconnects the second end portions 12″, 13″ of the first and second rails 12, 13. The first and second side rails 12, 13 are preferably arranged in parallel, and the first and second end members 11, 14 are preferably arranged in parallel, whereby the frame 10 forms a parallelogram. Preferably, the frame 10 forms a rectangle or a square.

The first end 20′ of the scissor-type guide 20 is connected at the first end portion 12′ of the first side rail 12. The scissor-type guide 20 may be connected to the first side rail 12 at the first end portion 12′ thereof, and/or the first end 20′ of the scissor-type guide 20 may be connected to the first end member 11. The tilt bracket 70 is connected at the second end portion 12″ of the first side rail 12. The tilt bracket 70 is either connected to the first side rail 12 at the second end portion 12″ thereof, and/or to the second end member 14.

Similarly, a second scissor-type guide 20 (not visible in the drawings) may have it's first end 20′ be fixed to the first end 13′ of the second side rail 13 and/or to the first end member 11. A second tilt bracket 70 may in this case be arranged at a second end 13″ of the second side rail 13 opposite to the first end 20′ of the scissor-type guide 20 and be fixed to the second side rail 13 at the second end 13″ thereof and/or to the second end member 14.

The shown blind 1 further comprises a scissor-type guide 20 and a set of lamellae 30. The scissor-type guide 20 guides the lamellae 30 from the retracted position—as shown in FIG. 1—where all of the lamellae 30 are positioned adjacent to the first end 12′, 13′ of the side rails 12, 13, to a fully extended position, where the lamellae 30 are distributed along the length of the side rails 12, 13 in the first longitudinal direction D₁. An example of lamellae 30 being extended to the fully extended position may be seen in FIG. 3C.

The scissor-type guide 20 is—in the shown embodiment—arranged inside the first side rail 12. Another scissor-type guide 20 may preferably be arranged in the second side rail 13. The side rails 12, 13 are closed structures comprising not only a framework for mounting the scissor type guide 20 with the lamellae 30, the conveyor 40, the tilt bracket 70 and possibly other parts of the blind 1/system 1′, but also providing a casing for the parts. As shown in FIGS. 1, 2A-B and 3A-E, the side rails 12, 13 and the end members 11, 14 form casings, encapsulating the component parts, at least to the side of the blind 1, system 1′ facing the opening 2. In FIGS. 1, 2A-B the back side, i.e. the side facing away from the opening 2 is shown without a cover. It is however noted that in other embodiments (not shown), also the side facing away from the opening may comprise a cover.

The system 1′/blind 1 comprises at least two lamellae 30. However, the system 1′/blind 1 may comprise the number of lamellae 30 needed to cover a particular opening 2. Thus, in general, the system 1′/blind 1 according to the invention comprises a plurality of lamella 30. Each lamella 30 is elongate, with a first end 30′ and a second end 30″ opposite to the first end 30′ in a longitudinal direction D2 of the lamella 30. The lamellae 30 preferably have a flat, e.g. slightly bent plate shaped structure. Each of the lamellae 30 are connected, at least at the first end 30′ thereof to the scissor-type guide 20 associated with the first side rail 12. The second end 30″ of each of the lamellae may be connected to a second scissor guide (not visible) associated with the second side rail 13. However, in other, not shown, embodiments, the second ends 30″ of the lamellae 30 may be connected to a different kind of guide mechanism. Also situations where the second ends 30″ of the lamellae 30 are not connected to a guide are conceivable, e.g. in connection with hanging lamellae.

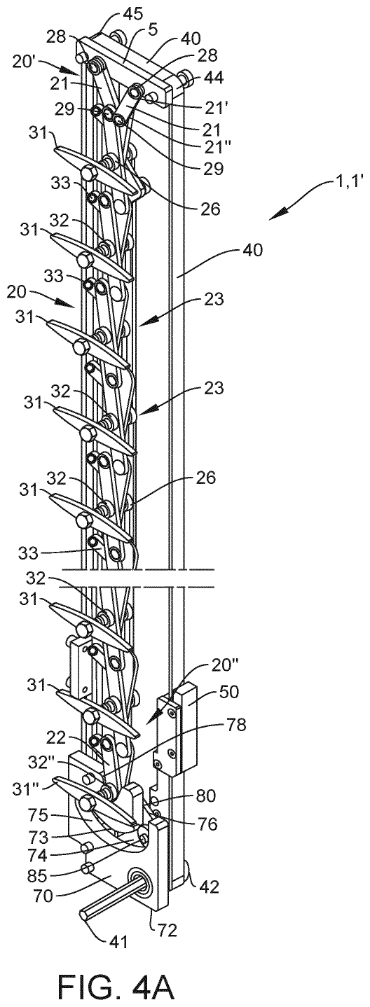

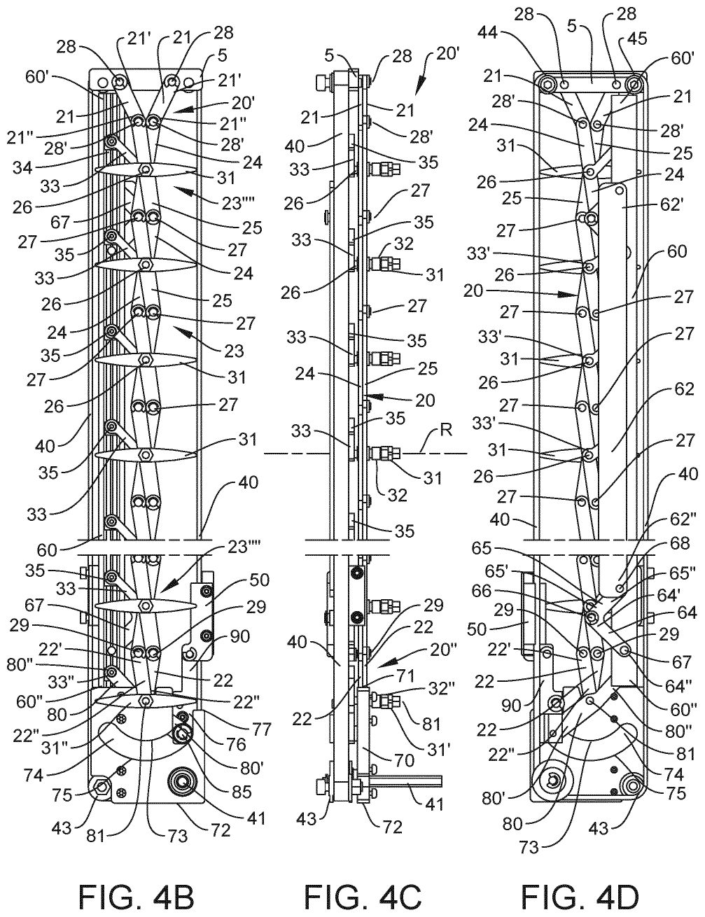

As shown in FIG. 1, the side rail 13 has a slit 13′″ formed in an externally facing surface 13″″, i.e. the side facing the opening 2. The slit 13′″ is elongate and formed along the longitudinal direction of the side rail 13, i.e. the first direction D1. The slit 13′″ is configured, such that lamella shafts 32 (see e.g. FIG. 4A) connected at one, first end 32′ (see e.g. FIG. 4C) of the lamella shaft 32 to the scissor-type guide, may extend there through and project from the externally facing surface 13″″, such that a lamella connector 31 (see e.g. FIG. 4A) may be connected to a second end 32′ (see e.g. FIG. 4C) of the lamella shaft 32. The lamella connector 31 is configured for connecting to an end of a lamella. In FIG. 1, only the externally facing surface 13″″ and the slit 13′″ of the second side rail 13 can be seen. It will however be appreciated that the first side rail 12, may have a corresponding slit 12′″ formed in an externally facing surface 12″″. This is shown in FIGS. 3A-E.

The lamella shafts 32 are connected to the scissor-type guide 20 at rotational joints 26 between first and second intersecting scissor members 24, 25 of a scissor link 23, see below. Thereby, the lamella shafts 32 define an axis of rotation, R (see e.g. FIG. 4C, for each lamella, this axis of rotation R being parallel with the longitudinal direction of the lamellae 30, i.e. the second direction D₂.

Although FIGS. 1, 2A-B and 3AE shows the side rails as fully covering at least the externally facing surfaces of the side rails 12, 13 (and of the end members 11, 14), it will be appreciated, however, that in other embodiments of the invention, the side rails 12, 13 may form only a framework for mounting the scissor type guide 20 with the lamellae 30, the conveyor 40, the tilt bracket 70 and possibly other parts of the blind 1/system 1′. In this way the first end 20′ of the scissor type guide 20 may be mounted to a first end 12′, 13′ of the side rail 12, 13 and the tilt bracket 70 may be mounted to the second end 12″, 13″ of the side rail 12, 13.

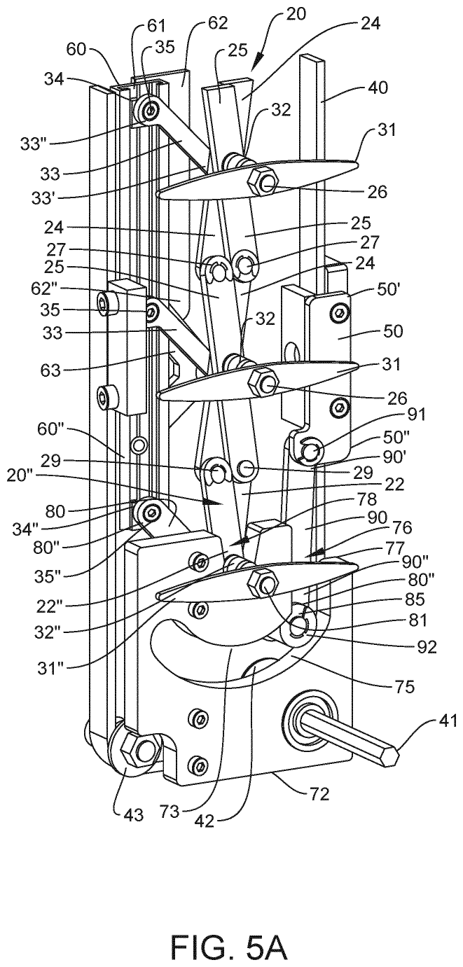

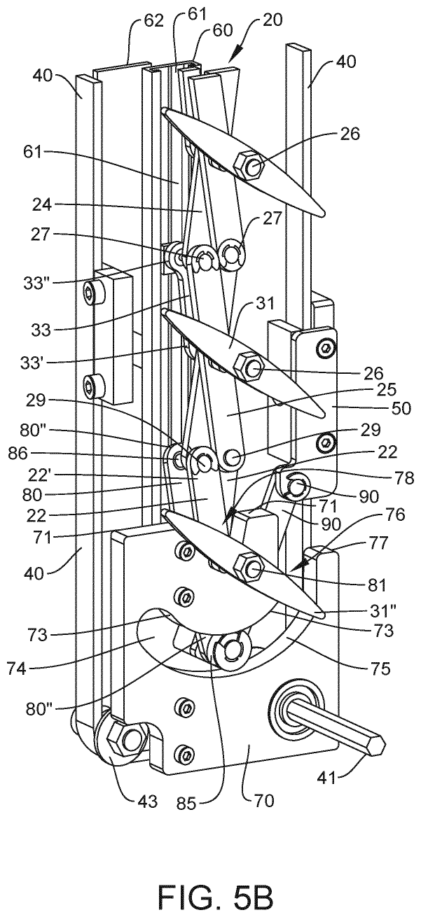

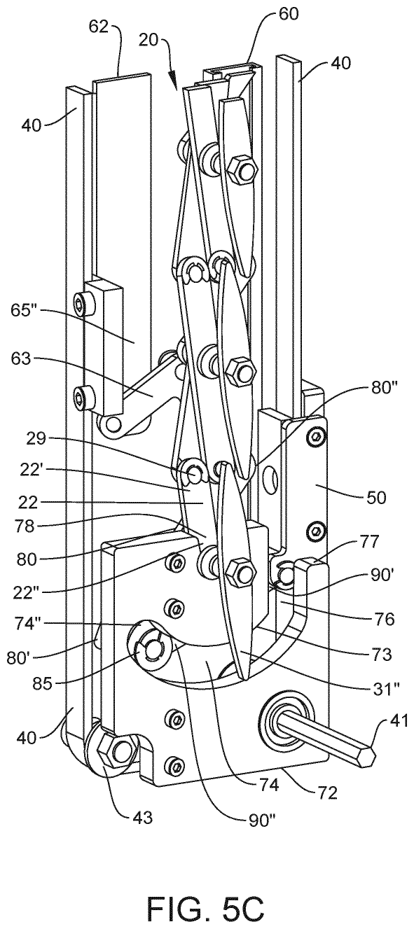

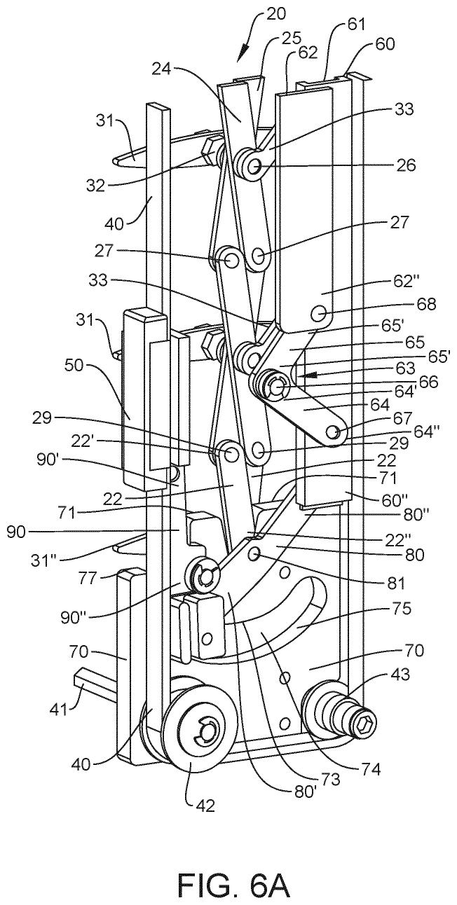

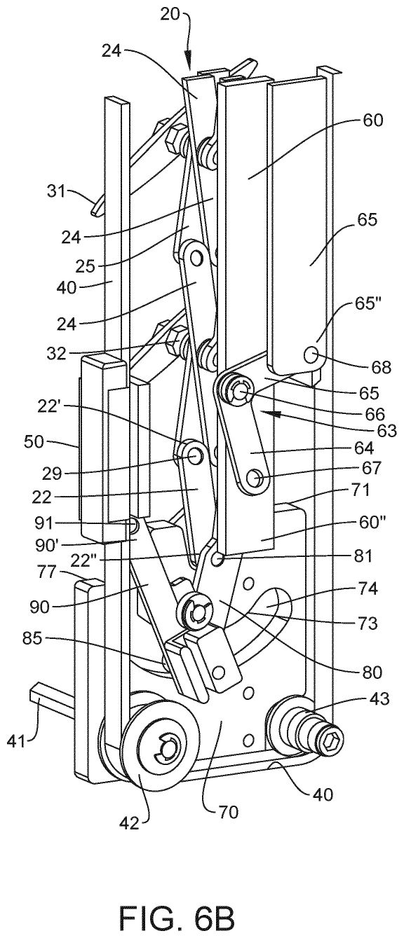

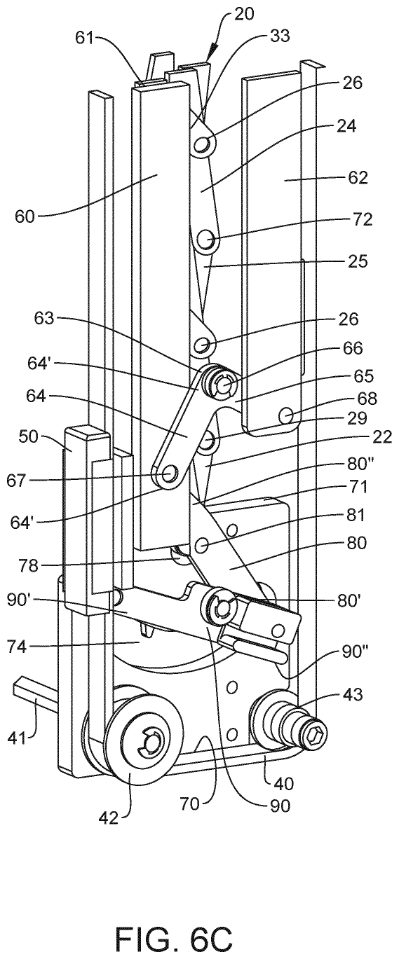

The first or second side rail 12, 13, or the first or second end members 11, 14 may further function as a cover/housing for a (not shown) drive mechanism, such as an electric motor. The drive mechanism is configured for moving said scissor-type guide and therewith the lamellae 30 between said fully retracted, or open, position shown in FIGS. 1, 2A and 3A to the fully extended position as shown in e.g. FIG. 3C, and further to the closed state as shown in FIG. 3E (as well as in FIG. 5C and FIG. 6C).

The drive mechanism (not shown) is preferably an electrical motor. However, in other embodiments the drive mechanism may be a mechanical device, for example a winch. In yet other embodiments, the drive mechanism may be a pneumatic or hydraulic device.

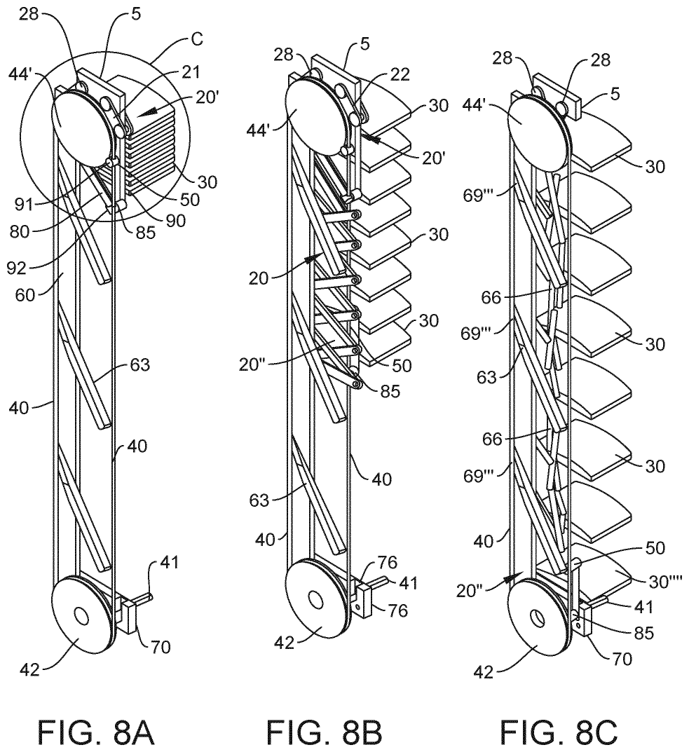

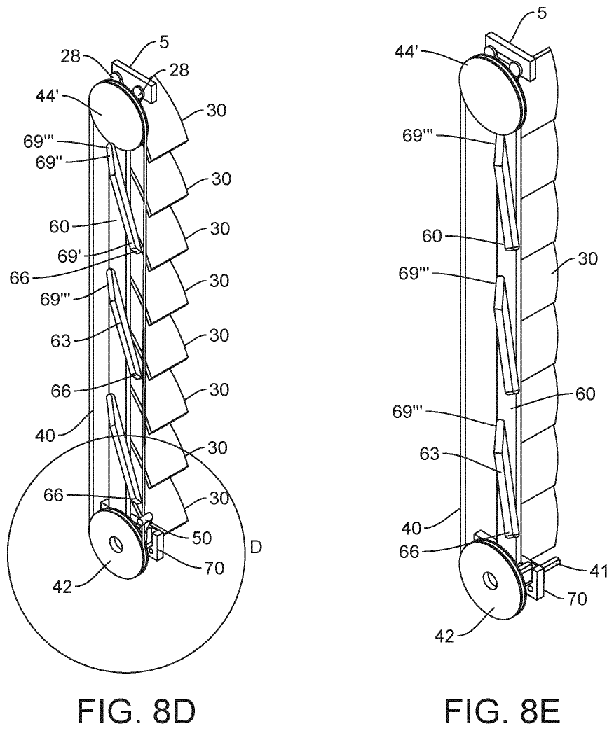

In either case, the drive mechanism drives the retraction and extension of the scissor-type guide 20 and thereby the lamellae 30 via the conveyor 40. In the embodiments shown in the figures, the conveyor 40 is an endless band, e.g. a cam belt. The conveyor 40 may be connected to the free, second end 20″ of the scissor-type guide 20 via a follower 50 fixed at a position of the endless belt (conveyor 40) as shown in e.g. FIGS. 1, 2A, 4A-D, 5A-C and 6A-C. In FIGS. 8A-E and 9A-B, another embodiment of a follower 50 is shown, also connected to a conveyor 40 in the form of an endless belt.

As shown in e.g. FIGS. 2A-B, the conveyor 40 in the form of the endless band is conveyed over first end conveyor wheels 44, 45, which are rotationally connected to the first end bracket 5, and over a second end conveyor wheel 43 and a conveyor drive wheel 42, both rotationally connected to the tilt bracket 70. In FIG. 2A the first end bracket 5 is connected to the first end 12′ of the first side rail 12. In FIG. 2B, the tilt bracket 70 is connected to the second end 12″ of the side rail 12. However, in other (not shown) embodiments, we note that the first end bracket 5 may form part of the first end member 11 and/or the tilt bracket 70 may form part of the second end member 14. We also note that in yet other embodiments, the first end bracket 5 and/or the tilt bracket may be connected directly to a building structure, such as in the frame of a window or a door. In yet other embodiments (not shown), the one or more of the first end conveyor wheels 44, 45 could be connected to another part of the side rail 12 or the first end member 11 than a first end bracket 5. In principle, the first end conveyor wheels 44, 45 could even be connected directly to a building structure, such as in the frame of a window or a door. Likewise, in yet other, not shown embodiments, the second end conveyor wheel 43 and/or the conveyor drive wheel 42, could be connected to another part of the second end 12″ of the side rail 12, or the second end member 14, than a tilt bracket 70. In principle, the second end conveyor wheel 43 and/or the conveyor drive wheel 42 could even be connected directly to a building structure, such as in the frame of a window or a door.

In the embodiment shown in FIG. 2B, the conveyor drive wheel 42 is associated with the tilt bracket 70, the second end 12″ of the first side rail 12, or the second end member 14. However, a person skilled in the art would realize that the conveyor drive wheel 42 may alternatively be located at the first end bracket 5, the first end 12′ of the first side rail 12, or the first end member 11, depending on a desired location of the (not shown) drive mechanism. In the embodiment shown in FIG. 2B, the (not shown) drive mechanism could preferably be provided in the second end member 14 and be connected to the conveyor drive wheel 42 by a conveyor drive shaft 41, e.g. as shown in FIG. 4A.

In further embodiments, only a single drive wheel 42 is provided at either the first end bracket 5, or the tilt bracket 70. Similar in further not shown embodiments a single first end wheel 44, correspondent to the first end wheels 44, 45 described above, may be provided in the end opposite the single drive wheel 42. An embodiment having a single drive wheel connected to the tilt bracket and a single first end wheel 44′ is shown in FIGS. 8A-E and 9A-B.

Preferably, the system 1′/blind 1 comprises only a single drive mechanism. The single drive mechanism (no shown) preferably both conveys the scissor type guide 20 (and lamellae 30) from the retracted position to the extended position, but also turns the lamellae from an open state to a closed state. This will be explained in further detail further below.

It will be appreciated, that instead of an endless band, the conveyor 40 may alternatively comprise an endless chain (not shown). It will also be appreciated, that alternatively, the conveyor 40 may alternatively (not shown) be provided by a limited length band, such as a cam belt, wound on spools at either end. This embodiment would require two drive mechanisms or an additional conveyor in order to provide a two way action. In other, also not shown embodiments instead of an endless belt the scissor-type guide 20 may be retracted and extended by a conveyor 40 in the form of a rotating cam shaft or a telescoping mechanism. In the latter case, the drive mechanism may be incorporated in the conveyor 40 in the form of a linear actuator.

FIGS. 3A-E show a section through a system 1′/blind 1 according to the invention. The blind 1 comprises a first side rail 12, a first end member 11 and second end member 14. Together with a second side rail 13 (not shown in FIGS. 3A-E), the first side rail 12, the first end member 11 and the second end member 14 may form a frame 10 for a set/plurality of lamellae 30 of the blind 1. In the example of FIGS. 3A-E there are eight lamellae 30. The blind 1 may be arranged in an opening of building structure, such as in a window in a wall or an overhead lighting opening in order to control the influx of sunlight.

The first side rail 12, as well as the second side rail 13, is an elongate structure having a longitudinal direction D₁. The side rail 12 has a first end portion 12′ shown in at the top in FIGS. 3A-E, and a second end portion 12″ shown at the bottom in FIGS. 3A-E. The first end member 11 connects the first end portions 12′, 13′ of the side rails 12, 13, respectively. Correspondingly, the second end member 14 connects the second end portions 12″, 13″ of the two side rails 12, 13.

The two side rails 12, 13 are arranged with their longitudinal axes in parallel. Correspondingly, the first and the second end members 11, 14 are arranged with their longitudinal axes in parallel.

The side rail 12, shown in FIGS. 3A-E has a slit 12′″ formed in an externally facing surface 12″″. The slit 12″′ is elongate and formed along the longitudinal axis of the side rail. A scissor-type lamella guide 20 such as shown in e.g. FIGS. 4A-D, and 7, is formed inside the side rail 12. Thus, the embodiment in FIGS. 3A-E corresponds to the embodiment shown in FIGS. 1 and 2A-B.

The lamellae 30 are elongate having a longitudinal axis formed in the second direction D₂. In FIGS. 3A-E only one end 30′ of the lamellae 30 are shown. It will be appreciated that the lamella 30 may have a suitable length and connect to the two side rails 12, 13 at each end 30′, 30″ of each lamellae 30.

FIG. 3A shows a situation where all of the lamellae 30 are gathered in a position adjacent to the first end member 11, i.e. the blind 1 is completely open and not shut. This situation or position corresponds to the position shown in FIG. 1 and in the detailed view of the first end 12′ of the first side rail 12 in FIG. 2A. The lamellae 30 are in the fully retracted position. From FIG. 2A it may be appreciated that this is obtained by the scissor-type guide 20 being in its fully retracted position, where the free, second end 20″ of the scissor-type guide 20 is brought as close as possible to the fixed, first end 20′ of the scissor-type guide 20. The scissor members 24, 25 (see more below) have—in this position—been packed as close together as possible. FIG. 8A shows another embodiment of the blind 1/system 1′, where the lamellae 30 and the scissor-type guide 20 are in the same retracted position as the blind 1/system 1′ in FIG. 3A.

In FIG. 3B the lamellae 30 has been partially extended towards the tilt bracket 70 provided at the second end 12″ of the first side rail 12 and the second end member 14. In this position, the scissor-type guide inside the first side rail 12 is also partly extended. The scissor-type guide 20 is not visible in FIG. 3A-E, because it is covered from by the first side rail 12 in this view. However, the state of the scissor type guide 20 may be seen in FIGS. 8A-E, which shows a different embodiment of a tilt mechanism and conveyor 40, but where the scissor-type guide is basically the same as in the FIGS. 1-7 embodiments. From FIG. 8B it may be appreciated, how the scissor members 24, 25 of each scissor link 23 have been rotated relative to each other to open up and extend the length of the scissor-type guide 20. Relative to the position in FIGS. 3A and 8A, this position has been obtained by the drive mechanism having driven the follower 50 on the conveyor 40 in the first direction D1, from an initial position adjacent to the first end 12′ of the side rail 12 and adjacent to the fixed, first end 20′ of the scissor-type guide 20 (see e.g. FIG. 1A and FIG. 8A), and towards the end bracket 70, the follower 50 pushing or dragging the free, second end 20″ of the scissor-type guide 20. In FIGS. 3B and 8B, the lamellae 30 and the scissor-type guide 20 are extended approximately half way between the first and second ends 12′, 12″ of the first side rail 12, and corresponding to halfway between the fixed first end 20′ of the scissor-type guide 20 and the end bracket 70. This means the free, second end 20″ of the scissor-type guide 20 is also located approximately halfway between the fixed first end 20′ of the scissor-type guide 20 and the end bracket 70.

We note that the position of the lamellae 30 and the corresponding position of the scissor-type guide 20 may also correspond to a resting position, where the lamellae 30 and the scissor-type guide 20 is not in movement, or to a situation, where the drive mechanism is dragging the free, second end 20″ of the scissor guide 20 towards the fixed first end 20′ of the scissor-type guide 20, i.e. the reverse of the action described immediately above, e.g. from a fully extended position as shown in FIG. 3C and FIG. 8C.

FIG. 3C (and FIG. 8C) shows the lamellae 30 in a fully extended position, where the lowermost lamella 30″″ is brought to a position adjacent the second end 12″ of the first side rail 12, which is also adjacent to the second end member 14, or the tilt member 70, which cannot be seen in this view in FIG. 3C, but is visible in FIG. 8C, and which is located inside the second end 12″ of the first side rail 12 as explained above. The other seven lamellae 30 are distributed evenly along the first direction D1, and the length of the first side rail 12. Also, the scissor-type guide 20 inside the first side rail 12 of FIG. 3C has been extended to a position, where it is fully extended (or close thereto). The extension of the scissor-type guide is visible in FIG. 8C. The scissor-type guide 20 is in a position corresponding to that of the scissor-type guide 20 shown in FIGS. 4A-D. 5A and 6A. In this position the free, second end 20″ of the scissor type guide is brought to rest at or in the tilt member 70. Preferably, the second end 20″ is in contact with a catch 78, e.g. formed as a notch in an edge of the tilt bracket 70, facing towards the fixed first end 20′ of the scissor guide 20, first edge 71. The lamellae 30 are still in an open position, i.e. the lamellae 30 have not been rotated.

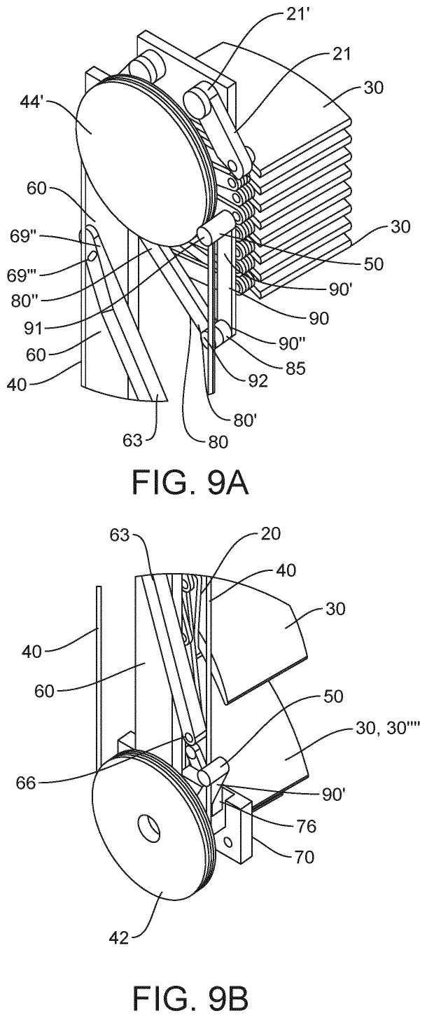

In FIG. 3D (and FIG. 8D) the lamellae 30 are in the fully extracted position, like described above in connection with FIG. 3C (and FIG. 8C). However, the lamellae 30 have been partially rotated (or tilted) around the rotational axis R defined by the lamella shaft 32. FIG. 3E, FIG. 8E and FIG. 9B show the lamellae 30 in a stage where they have been rotated so much that a plane defined by each of the individual lamellae 30 has been brought into alignment with planes defined of the other lamellae, to lie basically in the same plane, and where front and back edges of the lamellae 30 contact each other to provide a closed surface. Thereby, the blind 1/system 1′ closes/shuts the opening 2, in/at which it is arranged.

The rotation of the lamellae 30 is provided by a further movement of the follower 50 in the first direction D₁, from the fixed first end 20′ of the scissor towards the tilt bracket 70, as described in further detail below.

Attached to the follower 50 (or connected to the follower via a first arm 90 is a guide member 85. The guide member 85 may be a knob or cylindrical structure.

The guide member 85 is further connected to a tilt lever 80. The tilt lever 80 is further rotatably connected to the free, second end 20″ of the scissor-type guide 20 in a rotational joint 81, and rotateably and slidably to a tilt rail 60. The tilt rail 60 is elongate and is arranged in the first direction D1, and extends between the fixed, first end 20′ of the scissor-type guide 20 to the oppositely located tilt bracket 70.

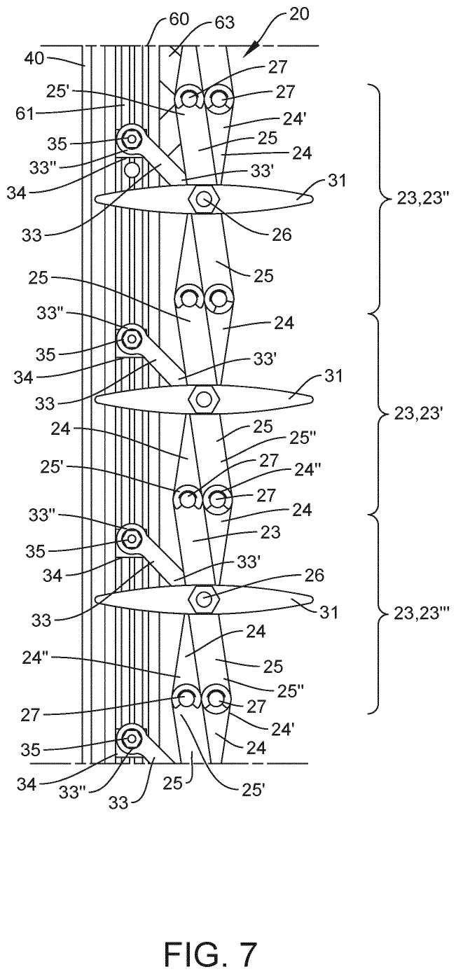

The tilt rail 60 is—via tilting arms 33—connected to each of the lamella shafts 32, see e.g. FIG. 7. Thereby, if the tilt rail 60 is translated in a third direction D₃, which is perpendicular to both the first direction D₁ and the second direction D₂ (i.e. the third direction D₃ is perpendicular to a plane defining the opening 2, see e.g. FIG. 1), the tilting arms 33 will cause the lamellae to rotate/tilt.

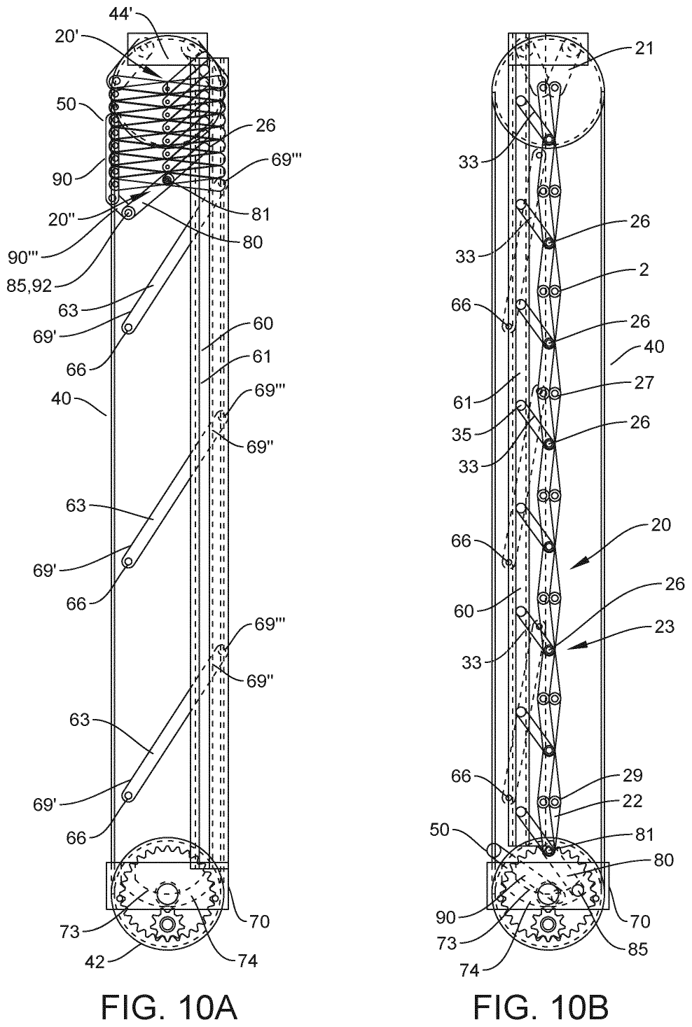

When the lamellae 30 have been brought to the fully extended position shown in FIG. 3C and FIG. 8C (but also FIGS. 4A-D, FIG. 5A, and FIG. 6A), the guide member 85 has been brought to a position where it is located at an entrance 76 to a guide track 74 formed in the tilt bracket 70. The guide track 74 is preferably curved. The curved guide track 74 is elongate and has a crescent shape or form an arc, such as an arc of a circle, extending generally in the third direction D₃. The entrance 76 to the guide track 74 is formed in the first direction D₁ through a surface, at the first edge 71 of the tilt bracket 70, which surface, and first edge 71 faces towards the fixed first end 20′ of the scissor type guide 20 (and the first end bracket 5 (in embodiments where such is present)), see e.g. FIG. 4B, FIG. 5A, FIG. 6A, FIG. 8B or FIG. 10B.

The curved guide track 74 comprises a curved first guide surface 73 formed in/on the tilt bracket 70, the curved first guide surface 73 being convex in the first direction D₁ and facing away from the fixed, first end 20′ of the scissor type guide 20. The curved guide track 74 further comprises a curved second first guide surface 75 formed in/on the tilt bracket 70, the curved second guide surface 75 being concave in the first direction D1, and facing towards the fixed first end 20′ of the scissor type guide 20.

A curved guide track 74, or at least a curved first guide surface 73, is preferred in embodiments, where a rotational axis for the lamella 30 closest to the second (free) end of the scissor-type guide 20 is not moveable during rotation of the lamellae 30. However, in other embodiments (not shown), where the rotational axis for the lamella 30 closest to the second (free) end of the scissor-type guide 20 is allowed to move during rotation of the lamellae 30, the guide track 74, or at least a curved first guide surface 73, may be differently shaped.

When the follower 50 is forced further in the direction of the tilt bracket 70 by the conveyor 40, relative to the position shown in FIG. 3C and FIG. 8C, the guide member 85 engages into the curved guide track 74, and is guided—at least along the curved first guide surface 73—whereby the guide member 85 is translated generally in the third direction D₃. Since the guide member 85 is connected to one end, first end 80′, of the 80 the tilt lever 80, the tilt lever 80 is forced to rotate around the rotational joint 81. This in turn will translate the tilt rail 60 in the third direction D₃, but opposite to the movement of the second guide member 85. As explained above, since the tilt rail 60 is connected to the lamella shafts 32 via the tilting arms 33, the tilting arms 33 will cause the lamellae 30 to rotate/tilt.

Now, with reference to especially FIG. 7, the scissor-type guide 20 will be explained in more detail. We note that scissor-type guides are known in the art. In relation to the present invention, the scissor-type guide may be any known type of scissor-type guide having rigid rotationally interconnected elongate members assembled to allow retraction and extension of the assembled scissor-type guide.

In e.g. FIGS. 4A-D a preferred type of scissor-type guide 20 is shown. A detailed view of a portion of the scissor-type guide 20 is shown in FIG. 7. The scissor-type guide 20 has a first end 20′, see e.g. FIG. 4B, which is intended for fixation to a fixed part of a building structure or a frame part associated with the system 1′, such as blind 1. In FIGS. 4A-D the first end 20′ of the scissor-type guide 20 is connected to a first end bracket 5, which may be connected directly to the building structure, or as shown in FIG. 2A to a frame part of the system 1, such as side rail 12.

The scissor-type guide 20 further comprises a free, second end 20″, opposite the fixed first end 20′, see e.g. FIG. 1A or 10A. In between the first and second ends 20′, 20″, the scissor type guide comprises a plurality of scissor links 23, see e.g. FIG. 4B and FIG. 7. The scissor-type guide 20 comprises at least two scissor links 23. Preferably, the scissor-type guide 20 comprises a plurality of scissor links 23. The number of scissor link 23 is adapted to the desired length, the scissor-type guide 20 is intended to be able to stretch.

Each scissor link 23 comprises two elongate scissor members, a first scissor member 24, and a second scissor member 25, which are rotationally interconnected—like scissors—in a rotational joint 26. The first scissor member 24 is elongate and has a first end 24′ facing toward the first end 20′ of the scissor-type guide 20, a second end 24″ facing away from the first end 20′ of the scissor-type guide 20, and a length L24. Likewise, the second scissor member 25 is elongate and has a first end 25′ facing toward the first end 20′ of the scissor-type guide 20, a second end 25″ facing away from the first end 20′ of the scissor-type guide 20, and a length L25. Preferably, and as shown in the figures the lengths L24, L25 of the first end second scissor members 24, 25 are equal, L24=L25. In the shown embodiments, the rotational joint 26 between the first and second scissor members 24, 25 of the scissor links, is provided centrally between the first ends 24′, 25′ and the second ends 24″, 25″ of the first and second scissor members 24, 25.

The ends 24′, 24″, 25′, 25″ of scissor members 24, 25 of one scissor link are rotationally connected to neighbouring scissor links 23. The scissor links 23 are configured for allowing the second end 20″ of the scissor-type guide 20 to be moved away from and towards the first end 20′ in a first direction D₁.

The first end 20′ of the scissor-type guide 20 may, as shown in e.g. FIG. 4B, be connected to the first end bracket 5 via two first end connection members 21, i.e. the scissor link 23″″ closest to the first end bracket 5, is connected to the first end bracket via the two first end connection members 21. The two first end connection members 21 are elongate, having two opposite ends, a first end 21′, a second end 21″, and a length L21. The length of both of the first connection members 21 is preferably half of the length L24, L25 of the scissor members 24, 25 (L21=½×L24=½×L25).

The first ends 21′ of the two first end connection members 21 are rotationally connected to the first end bracket 5 in rotational joints 28. The second ends 21″ of the two first end connection members 21 are rotationally connected to the scissor-type guide 20 in rotational joints 28′. The second end 21″ of one of the two first end connection members 21 is connected to the first end 24′ of the first scissor member 24 of the scissor link 23″″ closest to the first end bracket 5, and the second end 21″ of the other of the two first end connection members 21 is connected to the first end 25′ of the second scissor member 25 of the scissor link 23″″ closest to the first end bracket 5.

Other types of connections between the first end 20′ of the scissor-type guide 20 and the first end bracket 5, the first end member 11, first side rail 12 or the building structure than the rotationally connected first end members 21 are conceivable, e.g. the scissor members 24, 25 of the scissor link 23 at the first end 20′ may be connected to a rail or glider (not shown).

Now turning to FIG. 7, as also mentioned above, each scissor link 23 comprises two elongate scissor members 24, 25, a first scissor member 24 and a second scissor member 25. The scissor members 24, 25 are elongate, and have a first end 24′, 25′, and an opposite second end 24″, 25″. The first scissor member 24 has a length and the second scissor member 25 has a length. The length the first scissor member 24 and the length of the second scissor member 25 are—as shown—preferably equal.

The two scissor members 24, 25 of each of the scissor links 23 are joined in a rotational joint 26 formed centrally on the scissor members 24, 25, i.e. halfway between the first end 24′ and the second end 24″ of the first scissor member 24, and halfway between the first end 25′ and the second end 25″ of the second scissor member 25.

As shown in FIG. 7 the first ends 24′, 25′ of the scissor members 24, 25 of a first scissor link 23′, is—via rotational joints 27—connected to the second ends 24″, 25″ of the two scissor members 24, 25 of a neighbouring, second scissor link 23″ closer to the first end 20′ of the scissor-type guide 20 along the first direction D₁.

Correspondingly, the second ends 24″, 25″ of the two scissor members 24, 25 of the same, first scissor link 23′ are connected—via rotational links 27 to the first ends 24′, 25′ of the scissor members 24, 25 of a neighbouring, third scissor link 23″ closer to the second end 20″ of the scissor-type guide 20 along the first direction D₁.

The only exceptions to this are the scissor link 23″″ at the fixed first end 20′ of the scissor-type guide 20, and the scissor link 23″″″ closest to the free, second end 20″ of the scissor-type guide 20. The first ends 24′, 25′ of the scissor members 24, 25 of the scissor link 23″″ at the first end 20′ of the scissor guide 20 are—in the embodiments shown—connected to the above mentioned first end connection members 21. At the second end 20″ of the scissor-type guide 20 the scissor link 23″″″ is connected to a tilt lever 80 via two second end connection members 22.

The two second end connection members 22 are elongate, each having a first end 22′ and an opposite second end 22″, and having a length L22. Preferably, the length L22 of each of the second end connection members 22 is half of the length L24, L25 of the scissor members 24, 25 (L22=½×L24=½×L25). However, in other embodiments (not shown), other lengths may be used.

The second ends 24″, 25″ of the scissor members 24, 25 of the scissor link 23″″″ at the second end 20″ of the scissor guide 20 are connected to the first ends 22′ of the second end connection members 22 in rotational joints 29, see e.g. FIGS. 4B-D.

The second ends 22″ of the two second end connecting members 22 are both connected to the tilt lever 80 in the same rotational joint 81. Thus, the two second end connecting members 22 are allowed to rotate relative to the tilt lever 80.

The tilt lever 80 is non-rotatably connected to a lamella shaft 32″. Thus, the tilt lever 80 is configured for rotating the lamella 30″″ closest to the second end 20″ of the scissor guide 20. It will be appreciated that the tilt lever thus replaces the tilting arm 33 in relation to the lamella 30″″ closest to the second end 20″ of the scissor guide 20.

Now returning to FIG. 7, the figure also shows a tilt rail 60. The tilt rail is also visible in other figures. The tilt rail 60 is elongate, having a first end 61 close to the first end 20″ of the scissor-type guide 20, and a second end 60″ which is in the vicinity of the tilt bracket 70. The tilt rail 60 is connected to the first side rail 12, or to a second side rail 13 or to a framework of the opening 2 in which the blind 1/system 1′ is located. The connection between the tilt rail 60 and the side rail 12,13 (or the framework of the opening 2) at least allows the entire tilt rail to be translated in the third direction D₃.

A straight, elongate guide track 61 is formed in the tilt rail 60. The straight, elongate guide track 61 preferably extends along the entire length of the tilt rail 60, from the first end of the tilt rail 60 to the second end of the tilt rail 60. The straight, elongate guide track 61 is configured for receiving runners 34, see e.g. FIG. 5A. The runners 34 are slidably received in the straight, elongate guide track 61. There is one runner 34 for every lamella 30.

Also visible in FIG. 7 is that for each lamella 30 there is a tilt arm 33. The tilt arm 33 is non-rotatably connected to the lamella shaft 32. The lamella shaft is non-rotatably connected to the lamella connector 31, see e.g. FIG. 4A or FIG. 4C. A lamella 30 may be connected to the lamella connector 31. Each tilt arm 33 is elongate, having a first end 33′ which is non-rotatably to a lamella shaft 32, and a second end 33″ which is connected to a runner 34 in a rotational joint 35, see also FIG. 5A.

The tilt arms 33 are configured such that they form an angle of approximately 45° relative to the third direction D₃, when the scissor-type guide 2 is in its retracted position, as shown in FIGS. 1, 2A 3A, 8A, 9A and 10A, or in its extended position, shown in FIGS. 3C, 4A-D, 5, 6, 8C, 9B and 10B (and the lamellae 30 have not been tilted), or in a position there in between.

With regard to the lamella 30″″ closest to the second end 20″ of the scissor guide 20, this lamella 3″″ is not connected to the tilt rail 60 via a tilt arm 30 like the other lamellae 30, but via the tilt lever 80 as mentioned above.

The tilt lever 80 is an elongate structure having a first end 80′ and a second end 80″ opposite to the first end 80′. The above mentioned guide member 85 is attached to the first end 80′ of the tilt lever 80. The rotational joint 81, mentioned above, is preferably arranged at the middle of the tilt lever 80. The lamella 30″″ closest to the second end 20″ of the scissor guide 20 is connected to a lamella connector 31″ closest to the second end 20″ of the scissor guide 20. This lamella connector 31″ is non-rotationally connected to a lamella shaft 32″, which is closest to the second end 20″ of the scissor guide 20. The lamella shaft 32″, which is closest to the second end 20″ of the scissor guide 20, is in turn non-rotationally connected to the tilt lever 80.

The second end 80″ of the tilt lever 80 is connected to a runner 34″, see e.g. FIG. 5A, in a rotational joint 35″. The runner 34″ is similar to the runners 34 connected to the tilt arms 33, as described above.

The tilt lever 80 is configured such that it forms an angle of approximately 45° relative to the third direction D₃, when the scissor-type guide 2 is in its retracted position, as shown in FIGS. 1, 2A 3A, 8A, 9A and 10A, or in its extended position, shown in FIGS. 3C, 4A-D, 5, 6, 8C, 9B and 10B (and the lamellae 30 have not been tilted), or in a position there in between.

When the lamellae 30 are dragged from the retracted position as shown in FIGS. 1, 2A 3A, 8A, 9A and 10A, to a the extended position, shown in FIGS. 3C, 4A-D, 5, 6, 8C, 9B and 10B (or the reverse direction), the runners 34, 34″ glide/slide in the straight, elongate guide track 61 of the tilt rail 60.

When the tilt rail 60 is translated in the third direction D₃, by the rotation of the tilt lever 80 around lamella shaft 32″, the rotational joints 35, 35″ between the runners 34, 34″ allows the tilt rail to rotate the lamellae 30 via the tilt arms 33 (and the tilt lever 80 with respect to the lamella 30″″).

In principle only a single tilt rail 60 is necessary to tilt or rotate the lamellae 30. However, since the lamellae 30 are connected to the scissor-type guide 20, and scissor-type guides may be unstable for example due to slack in the rotational joints 26, between the scissor members 24, 25 of a scissor link 23, and/or in the rotational joints 27 between the scissor links 23′, 23″, 23″′, it may be necessary to provide stabilisation to the scissor link and the blind1/system 1′ when translating the tilt rail 60.

FIGS. 1, 2, 4, 5, and 6 show one embodiment of the scissor guide 20, tilt rail 60, and tilt bracket 70. In this embodiment, the tilt bracket comprises a catch 78 for stabilising the second end 20″ of the scissor-type guide 20. The catch 78 is shown in e.g. FIG. 5A. In this embodiment it is formed as a notch in an edge of the tilt bracket 70, facing towards the fixed first end 20′ of the scissor guide 20, first edge 71.

The catch 78 is configured for receiving the lamella shaft 32″ of the second end 20″ of the scissor-type guide 20, which is connected to the tilt lever 80. Thereby, when the lamellae 30 are in the fully extended position, as shown in e.g. FIG. 5a, the lamella haft 32″ is received in the catch 78, whereby movement of the second 20″ of the scissor guide 20 in the third direction D₃ is prevented.

Other ways of forming a catch 78 are conceivable, e.g. by providing protrusions (not shown) on the first edge 71, configured for receiving the lamella shaft 32″ of the second end 20″ of the scissor-type guide 20.

In the embodiment of the scissor guide 20, tilt rail 60, and tilt bracket 70, shown in FIGS. 8-10 no catch 78 is shown in connection with the tilt bracket 70. It will however be appreciated that this embodiment may also be provided with a catch 78.

The embodiment shown in FIGS. 1, 2, 4, 5, and 6 further show one more way of stabilising the scissor-type guide during tilting/rotation of the lamellae 30 by translating the tilt rail 60. In for example FIG. 4D it can be seen, that in this embodiment, the system 1′/blind 1 further comprises a tilt member 62.

The tilt member 62 is elongate, and has a first end 62′ extending towards the first end 20′ of the scissor-type guide 20, and a second end 62″ extending towards the second end 20″ of the scissor-type guide 20.

The tilt member 62 is connected to the tilt rail 60 in a parallelogram structure via two or more parallelogram connectors 63. In FIG. 4D, two parallelogram connectors 63 are shown. In the embodiment shown, the parallelogram connectors 63 have two elongate, perpendicularly oriented, arms 64, 65, a first arm 64 and a second arm 65.

As best illustrated in FIG. 6A, the first arm 64 of the parallelogram connector 63 is elongate having a first end 64′ and a second end 64″. The second arm 65 of the parallelogram connector 63 is elongate having a first end 65′ and a second end 65″. The two perpendicularly arranged arms 64, 65 intersect at their first ends 64′, 65′. At the intersection of the two perpendicularly arranged arms 64, 65 a rotational joint 66, rotationally joining the parallelogram connector 63 to the side rail 12 or to the framework surrounding the opening 2 in which the system 1′/blind 1 is arranged. Thereby, the arms 64, 65 of the parallelogram connector 63 may rotate relatively to the side rail 12, 13 and/or the framework.

The first arm 64 of parallelogram connector 63 is configured for connecting to the tilt rail 60. The tilt rail 60 is connected to the second end 64″ of the first arm of the parallelogram connector 63 in a rotational joint 67. Likewise, the second arm 65 of the parallelogram connector 63 is configured for connecting to the tilt member 62. The second end 65″ of the second arm 65 of the parallelogram connector 63 is connected to the tilt member 62 in a rotational joint 68.

FIG. 6A only shows an end of the blind 1/system 1′ close to the tilt bracket 70. Therefore, in FIG. 6A only one parallelogram connector 63 is illustrated. However, in FIG. 4D it can be seen that preferably, there are at least two parallelogram connectors 63. One parallelogram connector 63 connects the first end 60′ of the tilt rail 60 with the first end 62′ of the tilt member 62. The other parallelogram connector 63 connects the second end 60″ of the tilt rail 60 with the second end 62″ of the tilt member 62.

It will be appreciated that more than two parallelogram connectors 63 may be provided to connect the tilt rail 60 and the tilt member 62, the further parallelogram connectors 63 being distributed along the lengths of the tilt rail 60 and the tilt member 62.

The function of the tilt rail 60 and the tilt member 62 being connected via parallelogram connectors 63 may be appreciated by comparing FIGS. 6A-C. FIGS. 6A-C show a side of the system 1′/blind 1 that is intended for facing away from the opening 2 in which the system 1′/blind 1 is to be installed, i.e. the side facing the framework of the opening 2 in the building structure (not shown). FIGS. 5A-C show the same stages of the system 1′/blind 1 as FIGS. 6A-C, but from the side facing the opening 2 in which the system 1′/blind 1 is to be installed. In FIGS. 5A and 6A, the lamellae 30 are in the fully extracted position. The guide member 85 thereby has been brought into a position at the entrance 76 to the curved guide track 74 formed in the tilt bracket 70, as also discussed above. In FIG. 5B and FIG. 6B, the guide member 85 has been pulled into the guide track 74 and is being translated in an arc—following the arc-shaped guide track 74—generally in third direction D₃. The position of the guide member 85 about halfway through the guide track can be seen if FIG. 5B. This has caused the tilt lever 80 to rotate to an almost upright position. Due to the rotation around rotational joint 81, the second end 80″ of the tilt lever 80 describes a movement along an arc similar to the arc of the guide track, and since the second end 80″ of the tilt lever 80 is connected to the tilt rail 60, the tilt rail 60 is forced to translate in the third direction D₃ opposite to the guide member 85. By comparing FIGS. 6A and 6B it can be seen that the tilt rail 60 has been moved or translated to the left in the figures, while the tilt member 62 has moved to the right and down a little. The translation of the tilt rail has caused the lamellae 30 in the FIGS. 6A-C represented by the lamella connectors 31, to rotate towards a closed or shot state. This occurs because of the second ends 33″ of the tilting arms 33, connected to the tilt rail 60, compare FIGS. 5A and B, rotate relative to the now immobile scissor guide 20 around the rotation joints 26 and thereby turns the lamella shafts 32, and thereby the lamella connectors 31.

In FIGS. 5C and 6C, the lamellae 30 of the blind 1/system 1′ are brought into a state where they are completely closed (shut). In FIG. 5C, the guide member 85 has been translated to the end 74″ of the guide track 74. This has caused the second end 80″ of the tilt lever 80 to be rotated completely to the other side, as may be realized by comparing FIGS. 5A and 5C. The rotation of the tilt lever 80 has caused the tilt rail 60 to translate in the third direction D₃ opposite to the guide member 85. By comparing FIGS. 6A and 6C it can be seen that the tilt rail 60 has been moved or translated to all the way to the other side of (left in the figures), while the tilt member 62 has moved to the right and down a little (mostly down relative to FIG. 6B). Thereby, the lamellae 30 have been brought into a completely close state, i.e. they have been completely shut. By reversing the direction of the conveyor 40, the whole process may be reversed.

In further, not shown, embodiments the first and second arms 64, 65 of the parallelogram connectors are not arranged perpendicularly to each other. They may instead be formed with an acute angle or an obtuse angle between them.

In another, not shown, embodiment a similar function may be achieved with a parallelogram connector 63 being formed as a triangular plate with the rotational joints 66, 67, 68 provided in each corner (angle).

This parallelogram arrangement ensures that the translation of the tilt rail 60 in the third direction D3 occurs uniformly over the entire length of the tilt rail 60.

The embodiments shown in FIG. 8-10 comprises a different type of parallelogram arrangement to ensure that the translation of the tilt rail 60 in the third direction D3 occurs uniformly over the entire length of the tilt rail 60.

As can be seen in FIGS. 8C, 8D and 8E, the blind 1/system 1′ according to this embodiment only has a tilt rail 60 and no tilt member, as described in connection with FIGS. 4, 5, and 6. The blind 1/system 1′ comprises a set of parallelogram connectors 63. Three parallelogram connectors 63 are shown, but in other embodiments (not shown) there may be just two, or there may be four or more. Preferably, the parallelogram connectors 63 are distributed along the length of the tilt rail 60.

The parallelogram connectors 63, in this embodiment are of straight, elongate shape, having a first end 69′ and a second end 69″. The first ends of the parallelogram connectors 63 are connected to a side rail 12, 13, or directly to the framework of the opening 2 of the building structure in which the system 1′/blind 1 is installed. This connection is a rotational joint 66. The other end 69″ of the parallelogram connector 63 is connected to the tilt rail 60 in rotational joints 69′″. Thereby, the tilt rail 60 may be translated along an arc and generally in the third direction D₃, in the same manner as described above, and thereby moving the lamellae 30 between the completely open state, shown in FIG. 8C over the partially closed state, shown in FIG. 8D, to the completely closed state (shut), shown in FIG. 8E. Comparing especially FIG. 8C with FIG. 8E, it is realized that the tilt rail 60 has moved from one side (the side at the left) in FIG. 8C to the other side (at the right of the figure) in FIG. 8E in order to turn the lamellae 30 otherwise in the same way as described in connection with FIGS. 4-6 above.

As mentioned above, in some embodiments and as shown in all the embodiments in the figures, the follower 50 and the first end 80′ of the tilt lever 80 with the guide member 85 are not directly connected. As shown in e.g. FIG. 5A, the follower 50 and the first end 80′ of the tilt lever 80 may be connected via a first arm 90.

The first arm 90 is—in the shown embodiment—a straight, elongate structure, having a first end 90′ and a second end 90″. The first end 90′ of the first arm 90 is connected to the follower 50 in a rotational joint 91. The second end 90″ of the first arm 90 is connected to the first end 80′ of the tilt member 80 in a rotational joint 92. This allows the guide member 85 to be translated in the third direction D₃.

The follower 50, may as shown in FIG. 5A be an elongate structure, having first end 50′—facing first end 20′ of the scissor-type guide 20, and a second end 50″—facing the tilt bracket 70. As shown in FIG. 5A, preferably the first end 90′ of the first arm 90 is connected to the second end 50″ of the follower 50 in a rotational joint 91. Thereby, as the conveyor 40 pulls the follower in the first direction D₁, and towards the tilt bracket 70 in order to bring the lamellae 30 from the retracted position to the extended position, the follower 50 pushes the first arm 90, the tilt lever 80 and thereby the second end 20″ of the scissor-type guide 20 in the direction of the tilt bracket 70. By thereby pushing the guide member 85 in front of the follower 50, space is allowed for the guide member 85 to engage with the entrance 76 to the curved guide track 74 formed in the tilt bracket 70.

In the embodiment shown in FIGS. 8A-E and 9A-B, the follower 50 is shaped as knob. However, also in this embodiment the guide member 85 and the first end 80′ of the tilt lever 80 is connected by an elongate first arm 90. Again, the first arm 90 is elongate having a first end 90′ connected to the follower 50 in a rotational joint 91, and a second end 90″ connected to the first end 80′ of the tilt lever 80 in a rotational joint 92, see FIG. 9A.

The embodiment shown in FIGS. 10A-B is generally identical to the embodiment in FIGS. 8-9. The embodiment in FIGS. 10A-B differs in that the first arm has a small bend 90′″. This allows the guide member 85 to be brought closer to a centre plane of the blind 1/system 1′. Thereby the tilt bracket may be made narrower, whereby a slimmer blind 1/system 1′ may be obtained.

It will be appreciated, that the embodiments of the tilt system etc. shown and described in connection with FIGS. 1, 2, 4-6; the embodiments shown and described in connection with FIGS. 8-9; and the embodiments shown and described in connection with FIGS. 10A-B may be located inside side rails 12, 13 as shown in FIGS. 3A-E. However, as discussed, they may also be applied without side rails 12, 13.

It will also be realized that the use of the scissor guide 20 and tilt system 110 may be applied either within one or within each side rail 12, 13, or just one at each side (i.e. in systems 1′ without side rails 12, 13). In this case, some lamellae 30 may be connected to scissor-type guide 20 and tilt system 32, 33, 60, 63, 63, 70, 85, 90 in one side and other to the scissor type guide 20 and tilt system 32, 33, 60, 63, 63, 70, 85, 90 at the other side. For example every other lamella 30 connected at different sides to the tilt system 32, 33, 60, 63, 63, 70, 85, 90, and the other side of the lamella only being rotationally connected to the scissor guide 20

As discussed above, in some embodiments, where there is a scissor-type guide 20 and tilt system 32, 33, 60, 63, 63, 70, 85, 90 in just one side, the other side of the lamellae 30″, may be provide with another type of guide, allowing uniform extension of the lamellae 30 at both sides 30′ and 30″ thereof.

In general it will be appreciated that instead of a guide track 74 as such with two opposed curved surfaces 73 and 75 may not be necessary. In principle, the curved first guide surface 73 is sufficient for guiding the guide member 85 in order to tilt/rotate the lamellae. The curved second guide surface 75 especially aids in guiding the guide member, when the blind 1 is reversed from the closed state (shut) to the open state.

It is to be noted that the figures and the above description have shown the example embodiments in a simple and schematic manner. Many of the specific mechanical details have not been shown since the person skilled in the art should be familiar with these details and they would just unnecessarily complicate this description.

### PARTS LIST

A detail of FIG. 1
B detail of FIG. 1
C detail of FIG. 8A
D detail of FIG. 8D
D₁ first direction, longitudinal direction of first side rail and direction of movement of scissor-type guide and lamellae
D₁′ first direction, longitudinal direction of second side rail and direction of movement of scissor guide-type and lamellae
D₂ second direction, longitudinal direction of lamella
D₃ third direction
R rotational axis of lamellae
1′ System for closing an opening
1 blind
2 opening
5 first end bracket
10 frame
11 first end member of frame
12 first side rail
12′ first end portion of first side rail
12″ second end portion of first side rail
13 second side rail
13′ first end portion of second side rail
13″ second end portion of second side rail
14 second end member
20 scissor-type guide
20′ first end of scissor-type guide
20″ free end of scissor-type guide
21 first end connection member
21′ first end of first end connection member
21″ second end of first end connection member
22 second end connection member
22′ first end of second end connection member
22″ second end of second end connection member
23 scissor link
23′ first scissor link
23″ second scissor link
23′″ third scissor link
23″″ scissor link closest to the first end of the scissor guide
23′″″ scissor link closest to the second end of the scissor guide
24 elongate, first scissor member
24′ first end of first scissor member
24″ second end of first scissor member
25 elongate, second scissor member
25′ first end of second member
25″ second end of second scissor member
26 rotational joint between first and second scissor members of a scissor link
27 rotational joint between first and second scissor members of neighbouring scissor links
28 rotational joint between the first ends 21′ of the first end connection members 21 and first end bracket 5
28′ rotational joint between the second ends 21″ of the first end connection members 21 and the scissor members 24, 25 of the scissor link 23 at the first end 20′ of the scissor type guide 20
29 rotational joint between the first ends 22′ of the second end connection members 22 and the scissor members 24, 25 of the scissor link 23 at the second end 20″ of the scissor type guide 20
30 lamella
30′ first end of lamella
30″ second end of lamella
30′″ lamella closest to the first end of the scissor guide
30″″ lamella closest to the second end of the scissor guide
31 lamella connector
32 lamella shaft
32″ lamella shaft at the second end of the scissor-type guide
33 tilting arm
33′ first end of tilting arm
33″ second end of tilting arm
34 runner
35 rotational joint between runner 34 and second end of tilting arm
40 conveyor
41 conveyor drive shaft
42 conveyor drive wheel
43 second end conveyor wheel on tilt bracket
44 first end conveyor wheel
44′ singular first end conveyor wheel
45 first end conveyor wheel
50 follower
50′ first end of the follower—facing first end of the scissor-type guide
50″ second end of the follower—facing the tilt bracket
60 tilt rail
60′ first (upper, top) end of tilt rail
60″ second (lower, bottom) end of tilt rail
61 elongate guide track in tilt rail
62 tilt member
63 parallelogram connector
64 first arm of parallelogram connector (connecting to tilt rail)
64′ first end of first arm of parallelogram connector
64″ second end of first arm of parallelogram connector
65 second arm of parallelogram connector (connecting to tilt member)
65′ first end of second arm of parallelogram connector
65″ second end of second arm of parallelogram connector
66 rotational joint connecting parallelogram connector to side rail or framework
67 rotational joint between tilt rail and second end of first arm of parallelogram connector
68 rotational joint between tilt member and second end of second arm of parallelogram connector
70 tilt bracket
71 first edge of tilt bracket
72 second edge of tilt bracket
73 curved first guide surface formed in/on the tilt bracket
74 curved guide track formed in the tilt bracket
75 curved second guide surface formed in the tilt bracket
76 entrance to curved guide track formed in the tilt bracket
77 third edge of tilt bracket
78 catch formed in the first edge of tilt bracket
80 tilt lever
80′ first end of tilt lever
80″ second end of tilt lever
81 rotational joint between the second ends 22″ of the second end connection members 22, i.e. the second end 20″ of the scissor type guide 20, and the tilt lever 80.
85 guide member, formed at the first end of the tilt lever 80
86 rotational and slideable joint between the second end of the tilt lever 80 and the tilt rail 60
90 first arm
90′ first end of first arm
90″ second end of first arm
91 rotational joint connecting the first end of the first arm and the follower
92 rotational joint connecting the second end of the first arm and the tilt lever.

1. A system for closing an opening, the system comprising
a scissor-type guide comprising a fixed first end and a free, second end that is configured to be extended away from and retracted towards the first end in a first direction;
a tilt bracket arranged spaced apart from the first end at a fixed distance in the first direction;
a plurality of lamellae, each lamella of the plurality of lamellae having an elongate plate shape extending in a second direction perpendicular to said first direction, each lamella of the plurality of lamellae being rotatably connected to said scissor-type guide being guidable by the scissor-type guide in the first direction between
a retracted position adjacent to said fixed, first end of the scissor-type guide, and
an extended position, where the plurality of lamellae are distributed along the fixed distance between said first end of the scissor-type guide and the tilt bracket;
a conveyor configured to extract and contract the scissor type guide in said first direction;
a tilt rail configured for tilting said lamella between an open state and a closed state;
a curved first guide surface formed in or on said tilt bracket; and
a tilt lever connected to said free, second end of the scissor-type guide, to the tilt rail, and to the conveyor;
wherein the tilt lever comprises a guide member; and
wherein said system is configured for bringing the guide member into contact with the curved guide surface, whereby the guide member engages the curved guide surface and is translated in a third direction, which is perpendicular to both said first direction and said second direction, such that the tilt lever is rotated and translates the tilt rail in the third direction to rotate the plurality of lamellae.

2. A system according to claim 1, wherein the tilt bracket comprises a catch formed in a first edge thereof, said catch forming a bearing for a lamella shaft arranged through the tilt lever and connecting to the free end of the scissor-type guide.

3. A system according to claim 1, wherein the curved, first guide surface forms part of a guide track formed in said tilt bracket, said guide track also comprising a curved, second guide surface arranged opposite to said curved, first guide surface, and wherein the guide member is configured, such that it engaged both the curved, first guide surface and the curved, second guide surface.

4. A system according to claim 1, further comprising two parallelogram connectors being rotationally connected to the tilt rail and to, the tilt bracket in two separate rotational joints, and wherein each of said two parallelogram connectors are connected to a point by a rotational joint, which point is in a fixed position relative to—and between—the fixed first end of the scissor-type guide and the tilt bracket.

5. A system according to claim 4, further comprising a tilt member rotationally connected to each of said parallelogram connectors.

6. A system according to claim 1, wherein each lamella of the plurality of lamellae comprises a lamella shaft, which is rotationally connected to the scissor guide and which is non-rotationally connected to a tilt arm, and wherein the tilt arm is slideably and rotationally connected to an elongate guide track formed in the tilt rail.

7. A system according to claim 1, wherein the tilt lever comprises
a first end connected to the guide member, and to a follower fixedly connected to the conveyor; and
an opposite second end slideably and rotationally connected to the tilt member;
wherein a lamella shaft is arranged through a central portion of the tilt lever and connecting to the free end of the scissor-type guide.

8. A system according to claim 7, further comprising a first arm rotationally connected at one end to the follower, and rotationally connected at an opposite end to the first end of the tilt lever.

9. A system according to claim 1, further comprising a first side rail, wherein said first end of said scissor-type guide structure and said tilt bracket are arranged at opposite ends of said side rail.

10. A system according to claim 1 wherein the system is a blind.
